(19) United States
(12) Patent Application Publication
(10) Pub. No.: US 2009/0081541 A1
(43) Pub. Date: Mar. 26, 2009

(54) Bipolar Battery Having Carbon Foam Current Collectors

(76) Inventor: Kurtis C. Kelley, Washington, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/887,403

(22) PCT Filed: Mar. 29, 2006
(86) PCT No.: PCT/US2006/011449

§ 371 Date: Sep. 28, 2007

Related U.S. Application Data
(60) Provisional application No. 60/666,772, filed on Mar. 31, 2005.

(51) Int. Cl. H01M 4/08; H01M 4/66; H02J 7/00

(52) U.S. Cl. 429/185; 429/163; 29/623.2; 429/210; 320/137

(57) ABSTRACT

A bipolar battery includes a housing and a plurality of bipolar electrode plates aligned with respect to one another within the housing to form a cell between each pair of adjacent bipolar electrode plates. Each of the plurality of bipolar electrode plates includes an electrode substrate having a first face and a second face, an electrical connection element overlapping at least a portion of both the first face and the second face, a first carbon foam current collector on the first face of the substrate, a second carbon foam current collector on the second face of the substrate, and a chemically active paste on both the first and second carbon foam current collectors. A plurality of electrical separators are interleaved with the plurality of bipolar electrode plates.

This application claims priority to U.S. Provisional Patent Application No. 60/666,772, filed on Mar. 31, 2005.

### TECHNICAL FIELD

This invention relates generally to a battery and, more particularly, to a bipolar battery including carbon foam current collectors.

### BACKGROUND

Lead acid batteries are known to include at least one positive current collector, at least one negative current collector, and an electrolytic solution including, for example, sulfuric acid (H₂SO₄) and distilled water. In traditional lead acid batteries, both the positive and negative current collectors can include grid-like plates formed of lead. These batteries can be heavy due to the presence of lead grids and the peripheral components (grid lug, electrode current strap, and intercell connections) needed to support the monopolar configuration of many lead acid batteries (i.e., each battery electrode plate functions exclusively as either a positive plate or as a negative plate). Traditional lead acid batteries may also provide fairly low specific energy and specific power values. Further, a notable limitation to the durability of lead acid batteries is anodic corrosion of the lead-based components of the positive current collector.

Bipolar batteries have been proposed in an attempt to provide improved performance over traditional lead acid batteries. A bipolar battery may include bipolar electrode plates that can function as both positive and negative electrodes within the battery. Specifically, each individual electrode plate has both a positive and a negative active face. These two faces are electrically connected and, therefore, reside at the same electrical potential. The two faces, however, are separated by a barrier that is impermeable to the electrolytic solution in the battery. Therefore, despite being physically part of a single electrode plate, the two active faces of the bipolar electrode plates reside in separate cells of the battery. As a result, the bipolar electrode plate may serve both as a negative plate in one cell and as a positive plate in an adjacent cell.

As a result of their design, bipolar batteries may provide several advantages over traditional lead acid batteries. Bipolar batteries may include assemblies of low current cells that together are capable of carrying power at high voltage levels. Thus, there may be no need for the heavy lead components of traditional lead acid batteries (e.g., lugs, straps, busses, etc.), which carry the low voltage, high current power of these batteries. As a result, bipolar batteries may be made smaller and lighter than their monopolar counterparts. Further, bipolar batteries may provide improved specific energy and specific power values over traditional lead acid batteries.

U.S. Pat. No. 4,275,130 to Rippel et al. (“the '130 patent”) describes one example of a bipolar battery. While the '130 patent may provide lead acid batteries with lower weight and higher specific energy values as compared to traditional lead acid batteries, the lifespan of the bipolar batteries of the '130 patent may still be reduced due to corrosion. The '130 patent specifically notes that the life expectancy of at least one lead-based component in its bipolar battery has a life span of only five years due to the action of anodic corrosion.

The present invention is directed to overcoming one or more of the problems or disadvantages existing in the bipolar batteries of the prior art.

### SUMMARY OF THE INVENTION

One aspect of the present invention includes a bipolar battery including a housing and a plurality of bipolar electrode plates aligned with respect to one another within the housing to form a cell between each pair of adjacent bipolar electrode plates. Each of the plurality of bipolar electrode plates includes an electrode substrate having a first face and a second face, an electrical connection element overlapping at least a portion of both the first face and the second face, a first carbon foam current collector disposed on the first face of the substrate, a second carbon foam current collector disposed on the second face of the substrate, and a chemically active paste disposed on both the first and second carbon foam current collectors. A plurality of electrical separators are interleaved with the plurality of bipolar electrode plates.

A second aspect of the present invention includes a method of making a bipolar battery. The method includes supplying a plurality of electrode plates, each having at least one carbon foam current collector disposed on an electrode substrate. The plurality of electrode plates are aligned with respect to one another to form a cell between each pair of adjacent electrode plates, and a plurality of electrical separators are interleaved with the plurality of electrode plates. The method further includes supplying a housing, sealably fixing the electrode substrate of each of the plurality of electrode plates to the housing, and disposing an electrolyte into each cell formed between adjacent pairs of electrode plates.

### BRIEF DESCRIPTION OF THE DRAWINGS

FIG. 1 is a diagrammatic front view of a bipolar battery in accordance with an exemplary embodiment of the present invention;

FIG. 2 is a diagrammatic cross-sectional view of the bipolar battery of FIG. 1 taken along the line A;

FIG. 3 is a diagrammatic cross-sectional view of a bipolar electrode in accordance with an exemplary embodiment of the present invention.

### DETAILED DESCRIPTION

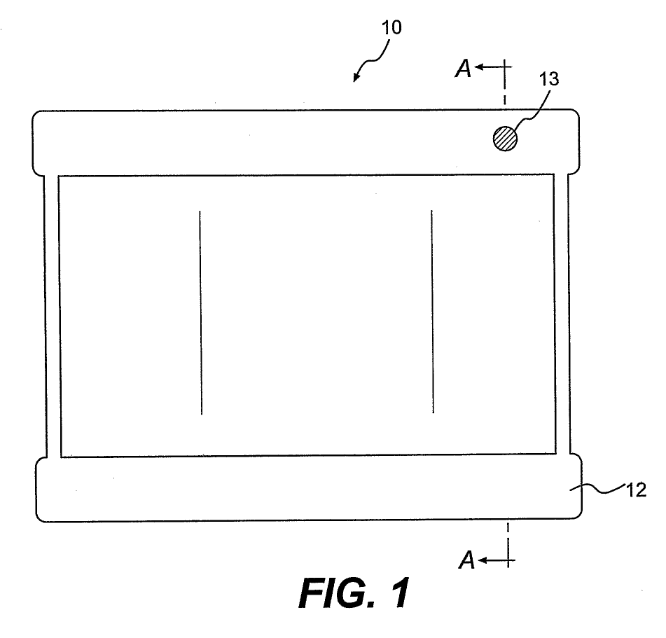

FIG. 1 illustrates a bipolar battery 10. Battery 10 may include a housing 12 that contains the electrical components of battery 10. Housing 12 may include any suitable material for sealing battery 10. In one embodiment, housing 12 may include a thermoplastic polymer. Housing 12 may also include polypropylene, ABS plastic (i.e., acrylonitrile butadiene styrene), polyvinylchloride, polyethylene, or any other suitable material. Housing 12 may be formed, for example, by injection molding or other suitable process. Battery 10 may also include a positive terminal 13 and a negative terminal (not shown) that provide electrical connection points between the electrical components of battery 10 and any external load.

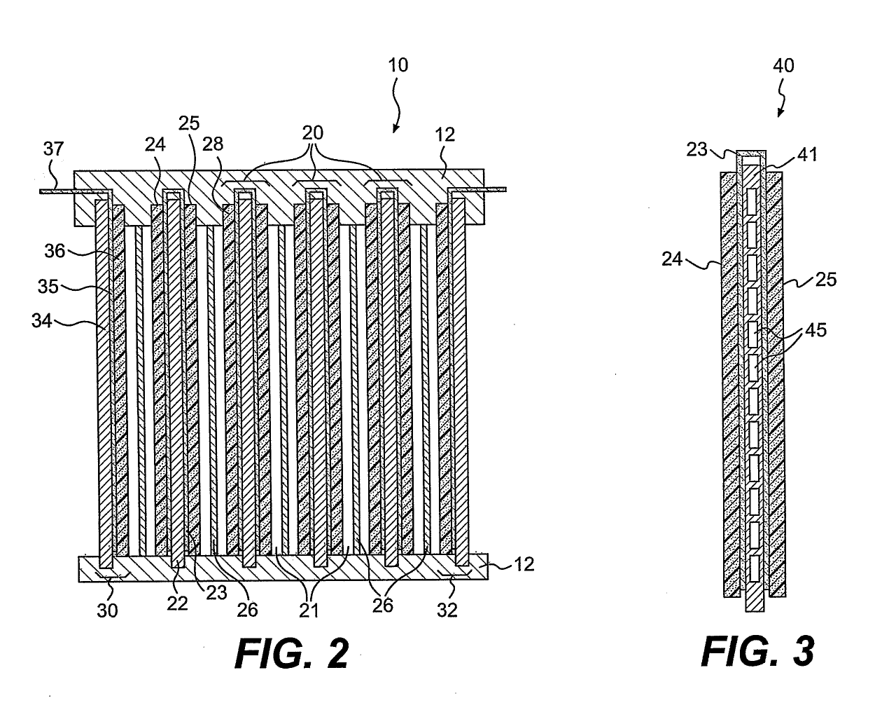

FIG. 2 provides a cross-sectional view of battery 10 taken along line A-A, as shown in FIG. 1. Battery 10 includes a plurality of bipolar electrode plates 20 aligned with respect to one another within housing 12. A cell 21 is formed between each pair of bipolar electrode plates 20. Battery 10 may include any number of bipolar electrode plates 20 and corresponding cells 21. Each cell 21 has a voltage potential determined by the battery chemistry (e.g., about 2 volts for a lead acid battery). Any number of bipolar electrode plates 20 may be added to battery 10 until a desired total voltage level for the battery is achieved.

Each bipolar electrode plate 20 can include a substrate 22, an electrical connection element 23, and current collectors 24 and 25. In bipolar electrode 20, current collectors 24 and 25 are electrically connected to one another and maintained at the same voltage potential. The electrical connection between current collectors 24 and 25 may be formed, as shown in FIG. 2, using electrical connection element 23. Alternatively, to form the electrical connection between current collectors 24 and 25, substrate 22 may include a conductive material. For example, substrate 22 may include a conductive polymer having, for example, conductive particles or fibers dispersed within a polymer matrix.

Substrate 22 may perform several functions in battery 10. For example, substrate 22 may provide rigid support for current collectors 24 and 25. Substrate 22 can also be used to separate cells 21 from one another. To function in this manner, substrate 22 may be bonded or attached to housing 12 to form a seal. Further, substrate 22 may be formed of a material that is impermeable to the electrolyte used in each cells 21. Such a configuration can prevent the flow of electrolyte between adjacent cells 21 and can, therefore, enable electrode plates 20 to operate in a bipolar capacity.

Substrate 22 may be formed from a thermoplastic material that softens and/or melts upon application of a sufficient amount of heat. This property may be useful, although not necessary, for attaching and sealing substrate 22 to housing 12. Specifically, substrate 22 may be joined to housing 12 through the application of heat that can cause these two components to bond together. Alternatively, substrate 22 may be attached to housing 12 through an injection molding process, through the use of an adhesive, or any other suitable method.

In one embodiment, substrate 22 may include polypropylene. In still other embodiments, substrate 22 may include one or more of ABS plastic, polyvinylchloride, polyethylene, and any other suitable material. In certain embodiments, substrate 22 may be formed from the same material used to form housing 12.

In embodiments where substrate 22 is formed from an electrically nonconductive material, electrical connection element 23 may establish an electrical connection between current collector 24 and current collector 25. Electrical connection element 23 may be applied to substrate 22 such that electrical connection element 23 overlaps at least a portion of both primary faces (e.g., where current collectors 24 and 25 are attached) of substrate 22. For example, prior to attaching current collectors 24 and 25 to substrate 22, electrical connection element 23 may be draped over or wrapped around substrate 22. Applying electrical connection element 23 to substrate 22 in this manner may enhance the integrity of the electrical connection formed between electrical connection element 23 and current collectors 24 and 25.

Electrical connection element 23 may be formed from any suitable conductive material. In one exemplary embodiment of the invention, electrical connection element 23 may include one or more carbon fibers. In other embodiments, electrical connection element 23 may include at least one of boron, graphite, carbon, a conductive polymer, and metals. Further, electrical connection element 23 may include at least one of carbon fiber cloth, carbon fiber tape, unwoven carbon fiber cloth, a single carbon fiber, a plurality of carbon fibers, a bundle of carbon fibers, graphite fiber cloth, graphite fiber tape, unwoven graphite fiber cloth, a single graphite fiber, a plurality of graphite fibers, and a bundle of graphite fibers.

As previously noted, each bipolar electrode plate 20 includes current collectors 24 and 25 disposed on opposing faces of substrate 22. Each current collector 24, 25 may be formed from a porous carbon material such as, for example, carbon foam. The carbon foam of an exemplary embodiment of the invention may have an average pore size of between about 20 μm and about 2.0 mm, and a total porosity value for the carbon foam may be at least 60%. In other words, at least 60% of the volume of the carbon foam structure may be included within pore structures. Moreover, the carbon foam may have an open porosity value of at least 90%. Therefore, at least 90% of pore structures included in current collectors 24, 25 are open to adjacent pores such that the pore structures of the carbon foam form a substantially open network. This open network can allow chemically active paste deposited on each current collector 24, 25 to penetrate within the carbon foam structure. In certain forms, the carbon foam may offer sheet resistivity values of less than about 1 ohm/cm. In still other forms, the carbon foam may have sheet resistivity values of less than about 0.75 ohm/cm.

The disclosed foam material may include any carbon-based material having a reticulated pattern including a three-dimensional network of struts and pores. The foam may comprise either or both of naturally occurring and artificially derived materials.

In addition to carbon foam, graphite foam may be used to form current collectors 24, 25. One such graphite foam, under the trade name PocoFoam™, is available from Poco Graphite, Inc. The density and pore structure of graphite foam may be similar to carbon foam. A primary difference between graphite foam and carbon foam is the orientation of the carbon atoms in the graphite foam. For example, in carbon foam, the carbon may be primarily amorphous. In graphite foam, however, much of the carbon is ordered into a graphite, layered structure. Because of the ordered nature of the graphite structure, graphite foam can offer higher conductivity than carbon foam. PocoFoam™ graphite foam may exhibit electrical resistivity values of between about 100:Σ/cm and about 400:Σ/cm.

Bipolar electrode plates 20 may be made by disposing an electrical connection element 23 on substrate 22, as described above, and sandwiching substrate 22 and electrical connection element 23 between two layers of carbon foam, or other type of porous carbon material, to form a stacked structure. Heat may be applied to the stacked structure to soften and/or slightly melt substrate 22. Softening and/or melting of substrate 22 may encourage permeation of at least a portion of the material of substrate 22 into the pores of the carbon foam. In addition to heat, pressure may also be applied to the stacked structure. The application of external pressure may aid in forcing the softened substrate 22 into the pores of the carbon foam. In one exemplary embodiment, heat and pressure may be applied simultaneously. In certain situations, however, heat may be applied exclusive of pressure. In still other situations, the application of heat may occur separate from the application of pressure.

Alternatively, carbon foam current collectors 24, 25 may be bonded to substrate 22 using an adhesive. For example, a layer of epoxy or other suitable adhesive may be spread over the opposing faces of substrate 22 and electrical connection element 23. Carbon foam current collectors 24, 25 may then be placed onto substrate 22. The adhesive may permeate the pores of the carbon foam and bond current collectors 24, 25 to substrate 22 even without applying heat or pressure. Nevertheless, the application of heat and/or pressure may facilitate permeation of the adhesive material into the pores of the carbon foam.

A chemically active paste may be applied to current collectors 24, 25 to complete the preparation of bipolar electrode plates 20. The chemically active paste that is applied to the current collectors 24, 25 may be substantially the same in terms of chemical composition. For example, the paste may include lead oxide (PbO). Other oxides of lead may also be suitable. The paste may also include various additives including, for example, varying percentages of free lead, structural fibers, conductive materials, carbon, and extenders to accommodate volume changes over the life of the battery. The constituents of the chemically active paste may be mixed with a small amount of sulfuric acid and water to encourage permeation of the paste into pores of the carbon foam.

In the disclosed bipolar battery, no processing or curing of the chemical active paste on current collectors 24, 25 is required. Optionally, however, the chemically active paste may be allowed to dry on current collectors 24, 25.

To form battery 10, a plurality of bipolar electrode plates 20 may be stacked together. Further, an electrical separator 26 may be disposed between each pair of bipolar electrode plates 20. Electrical separators 26 may exhibit two primary characteristics. First they can be formed of electrically insulating materials to prevent the positive current collector (25, for example) of one cell from shorting with the negative current collector (28, for example) of that cell. Electrical separators 26 can also be permeable to the electrolyte used in battery 10. This permeability enables ionic transport within cells 21. Electrical separators 26 may include a wide range of materials in many different configurations. For example, electrical separators 26 may include porous polymer materials, mats of glass fibers, porous aluminum nitride sheets and/or fibers, or any other suitable materials.

In addition to bipolar electrode plates 20, bipolar battery 10 may also include a positive terminal electrode plate 30 and a negative terminal electrode plate 32. Both positive terminal electrode plate 30 and negative terminal electrode plate 32 are of similar construction and can include a substrate 34, a terminal connector 35, and a current collector 36. As in the construction of bipolar electrode plates 20, substrate 34 of positive terminal electrode plate 30, for example, may be attached to housing 12. In one embodiment of the invention, substrate 34 is sealed to housing 12 and serves as an outer wall of battery 10. Substrate 34 may be made of materials such as, for example, polypropylene. In still other embodiments, substrate 34 may include one or more of ABS plastic, polyvinylchloride, polyethylene, and any other suitable material. While not necessary, substrate 34 may be formed from the same material used to form housing 12.

Terminal connector 35 may establish an electrical conduction path between current collector 36 and electrical elements external to battery 10 (e.g., any type of element that may draw charge from or supply charge to battery 10). While terminal connector 35 may be connected to current collector 36 in any suitable manner, in one embodiment, terminal connector 35 may be disposed between substrate 34 and current collector 36. Terminal connector 35 may be formed from any suitable conductive material. In one exemplary embodiment, terminal connector 35 may include one or more carbon fibers. In other embodiments, terminal connector 35 may include at least one of boron, graphite, carbon, a conductive polymer, metals, and any combination thereof. Further, terminal connector 35 may include at least one of carbon fiber cloth, carbon fiber tape, unwoven carbon fiber cloth, a single carbon fiber, a plurality of carbon fibers, a bundle of carbon fibers, graphite fiber cloth, graphite fiber tape, unwoven graphite fiber cloth, a single graphite fiber, a plurality of graphite fibers, and a bundle of graphite fibers.

To facilitate the formation of an electrical conduction path with units external to battery 10, at least a portion of terminal connector 35 may extend through housing 12 and outside of battery 10 to establish a contact 37. Contact 37 may itself serve as a terminal of battery 10. Alternatively, a conductive terminal material may be attached to contact 37 to form a terminal of battery 10.

Current collector 36, like current collectors 24 and 25, may be formed from a porous carbon material such as, for example, carbon foam. The carbon foam of current collector 36 may include all of the same characteristics and properties of the carbon foam of current collectors 24 and 25. Further, a chemically active paste may be included on current collector 36.

Battery 10 may be constructed by assembling together an appropriate number of bipolar electrode plates 20 to provide a total desired voltage potential for battery 10. Bipolar electrode plates 20, together with positive terminal electrode plate 30 and negative terminal electrode plate 32, may be interleaved with electrical separators 26 to form an electrode stack. The electrode stack can be assembled together with housing 12 in a variety of ways. For example, housing 12 may be attached to electrodes 20, 30 of the electrode stack using an adhesive or through the application of heat to join and seal each substrate 22, 34 of the electrodes to housing 12.

Alternatively, housing 12 may be molded about electrode plates 20, 30 using any suitable molding process (e.g., injection molding). In such a process, substrates 22, 34, and optionally other components of electrode plates 20, 30 (e.g., current collectors, electrical connection elements, etc.), may be sized to extend into an injection mold that may be used to form housing 12. Thus, upon injecting the housing material into the mold, the portions of components included within the mold may be encapsulated by the housing material. As a result, housing 12 may be bonded and sealed together with substrates 22, 34 and, optionally, other components of electrodes 20, 30.

As an additional step in the assembly of battery 10, a thin layer of polymer (e.g., polypropylene or other suitable material) may be applied to at least a portion of a component that extends within the mold used to form housing 12. Such a polymer layer may protect the carbon foam and/or carbon fiber materials included in portions of electrode plates 20, 30, 32 during the injection molding process.

Assembly of bipolar battery 10 creates sealed cells 21 that are substantially and/or completely fluidly isolated from other cells 21. The electrolyte for each cell 21 may be disposed in each cell in several ways. For example, in one exemplary embodiment, a plurality of access ports (not shown) may be formed through housing 12 such that the electrolyte may be flowed, injected, or otherwise disposed into each cell 21. After disposing electrolyte within each cell, the access ports may be sealed with a valve, a removable plug, a permanently installed plug, or any other suitable sealing device and/or process. The electrolyte may include an acid such as sulfuric acid (H₂SO₄), for example, and distilled water. Other electrolytes, however, may also be suitable.

After providing cells 21 with electrolyte, battery 10 may be subjected to a charging (i.e., formation) process. During this charging process, the chemically active paste on the current collector of positive terminal electrode plate 30 and on the positive active faces of bipolar electrode plates 20 is electrically driven to lead dioxide (PbO₂). Conversely, the chemically active paste on the current collector of negative terminal electrode 32 and on the negative active faces of bipolar electrode plates 20 may be converted to sponge lead.

FIG. 3 illustrates a bipolar electrode plate 40 according to another exemplary embodiment of the present invention. Like bipolar electrode plates 20 (FIG. 2), bipolar electrode plate 40 includes a substrate 41, an electrical connection element 23, and current collectors 24 and 25, which may include carbon foam. In this embodiment, however, substrate 41 may include a plurality of channels 45 that extend into and possibly through substrate 41. Flowing air, water, or other another coolant through channels 45 will enable cooling of bipolar electrode plate 40. In one embodiment of the invention, channels 45 may extend through housing 12 such that channels 45 are accessible from outside of battery 10.

### INDUSTRIAL APPLICABILITY

The disclosed bipolar battery may be useful in any of a wide variety of applications where there is a need for low cost, lightweight, small, and/or durable energy storage devices. For example, such batteries may be used as power sources in automobiles (including hybrid and electric vehicles), heavy equipment, standby power facilities, personal electronics, and many other applications. The disclosed batteries may offer large specific energy values and significant resistance to corrosion.

In general, carbon oxidizes only at very high temperatures and will resist corrosion even in highly corrosive environments. Because positive terminal electrode plate 30, negative terminal electrode plate 32, and bipolar electrode plates 20 may include carbon foam current collectors, these electrodes may resist corrosion even when exposed to highly corrosive environments. For example, these electrodes may resist corrosion even when exposed to sulfuric acid and to the anodic potentials in a lead acid battery. As a result, bipolar battery 10 may offer a significantly longer service life as compared to batteries without carbon foam current collectors.

Additionally, the porous nature of the carbon foam included in positive terminal electrode plate 30, negative terminal electrode plate 32, and bipolar electrode plates 20 may translate into batteries having high specific energy values. Specifically, the large amount of surface area provided by the carbon foam (e.g., more than 2000 times the amount of surface area provided by conventional lead current collectors) enables intimate integration of the chemically active paste with the current collectors of positive terminal electrode plate 30, negative terminal electrode plate 32, and bipolar electrode plates 20. Therefore, electrons produced in the chemically active paste at a particular reaction site may travel only a short distance through the paste before encountering the conductive carbon foam of an electrode current collector. This may result in improved specific energy values for bipolar battery 10. In other words, bipolar battery 10, when placed under a load, may sustain its voltage above a predetermined threshold value for a longer time than bipolar batteries including traditional lead materials.

It will be apparent to those skilled in the art that various modifications and variations can be made in the disclosed bipolar battery without departing from the scope of the disclosure. Additionally, other embodiments of the bipolar battery will be apparent to those skilled in the art from consideration of the specification. It is intended that the specification and examples be considered as exemplary only, with a true scope of the disclosure being indicated by the following claims and their equivalents.

What is claimed is:

1. A bipolar battery, comprising:
a housing;
a plurality of bipolar electrode plates aligned with respect to one another within the housing to form a cell between each pair of adjacent bipolar electrode plates, wherein each of the plurality of bipolar electrode plates includes:
an electrode substrate having a first face and a second face;
an electrical connection element overlapping at least a portion of both the first face and the second face;
a first carbon foam current collector disposed on the first face of the substrate;
a second carbon foam current collector disposed on the second face of the substrate; and
a chemically active paste disposed on both the first and second carbon foam current collectors; and
a plurality of electrical separators interleaved with the plurality of bipolar electrode plates.

2. The bipolar battery of claim 1, further including an electrolyte disposed within the cells formed between adjacent pairs of bipolar electrode plates.

3. The bipolar battery of claim 1, wherein the electrode substrate of each of the plurality of bipolar electrode plates is sealably fixed to the housing.

4. The bipolar battery of claim 1, further including channels that extend through the housing and into the electrode substrate of at least one of the plurality of bipolar electrode plates.

5. The bipolar battery of claim 1, further including a positive terminal electrode plate and a negative terminal electrode plate each having:
a substrate sealably fixed to the housing;
a carbon foam current collector disposed on the substrate; and
an electrical connection element in electrical contact with the carbon foam current collector.

6. The bipolar battery of claim 5, wherein the electrical connection elements of both the positive terminal electrode plate and the negative terminal electrode plate extend through the housing.

7. The bipolar battery of claim 5, wherein the substrate of the positive terminal electrode plate forms a first wall of the housing, and the substrate of the negative terminal electrode plate forms a second wall of the housing.

8. The bipolar battery of claim 1, wherein the plurality of electrical separators comprise aluminum nitride.

9. A method of making a bipolar battery, the method comprising:
supplying a plurality of electrode plates each including at least one carbon foam current collector disposed on an electrode substrate;
aligning the plurality of electrode plates with respect to one another to form a cell between each pair of adjacent electrode plates;
interleaving a plurality of electrical separators with the plurality of electrode plates;
supplying a housing;
sealably fixing the electrode substrate of each of the plurality of electrode plates to the housing; and
disposing an electrolyte into each cell formed between adjacent pairs of electrode plates.

10. The method of claim 9, wherein supplying the plurality of electrode plates further includes:
supplying a positive terminal electrode plate;
supplying a negative terminal electrode plate; and
supplying at least one bipolar electrode plate disposed between the positive terminal electrode plate and the negative terminal electrode plate.

11. The method of claim 10, wherein the supplying at least one bipolar electrode plate further includes:
disposing an electrical connection element on the electrode substrate of each bipolar electrode plate such that the electrical connection element overlaps at least a portion of both a first face and a second face of the electrode substrate;
attaching a first carbon foam current collector on the first face of the electrode substrate;
attaching a second carbon foam current collector on the second face of the electrode substrate; and
disposing a chemically active paste on both the first and second carbon foam current collectors.

12. The method of claim 11, wherein attaching the first carbon foam current collector and attaching the second carbon foam current collector further include applying heat and pressure.

13. The method of claim 9, wherein disposing an electrolyte further includes:
forming an access port through the housing in an area of each cell;
injecting the electrolyte into each cell; and
sealing each access port.

14. The method of claim 9, wherein supplying the housing includes injection molding the housing.

15. The method of claim 9, further including charging the bipolar battery.

16. A bipolar electrode plate for a battery, the bipolar electrode plate comprising:
an electrode substrate having a first and second face;
an electrical connection element disposed on the electrode substrate such that the electrical connection element overlaps at least a portion of both the first face and the second face of the electrode substrate;
a first carbon foam current collector attached to the first face of the electrode substrate;
a second carbon foam current collector attached to the second face of the electrode substrate; and
a chemically active paste disposed on both the first and second carbon foam current collectors.

17. The bipolar electrode plate of claim 16, wherein both the first carbon foam current collector and the second carbon foam current collector electrically contact the electrical connection element.

18. The bipolar electrode plate of claim 16, wherein the electrode substrate is a thermoplastic material.

19. The bipolar electrode plate of claim 16, wherein the electrode substrate is polypropylene.

20. The bipolar electrode plate of claim 16, wherein the electrical connection element includes one or more carbon fibers.

21. The bipolar electrode plate of claim 16, wherein the first and second carbon foam current collectors include graphite foam.

22. The bipolar electrode plate of claim 16, wherein the first and second carbon foam current collectors have a total porosity value of at least 60%.

23. The bipolar electrode plate of claim 16, wherein the first and second carbon foam current collectors have an open porosity value of at least 90%.

24. The bipolar electrode plate of claim 16, wherein the first and second carbon foam current collectors have an average pore size of between about 20 μm and about 2.0 mm.

25. A bipolar battery, comprising:
a thermoplastic, molded housing;
a positive terminal electrode plate including a carbon foam current collector disposed on a substrate, the substrate being sealably fixed to the housing, and a positive terminal electrical connection element extending through the housing and making electrical contact with the carbon foam current collector of the positive terminal electrode plate;
a negative terminal electrode plate including a carbon foam current collector disposed on a substrate, the substrate being sealably fixed to the housing, and a negative terminal electrical connection element extending through the housing and making electrical contact with the carbon foam current collector of the negative terminal electrode plate;
a plurality of bipolar electrode plates disposed between the positive terminal electrode plate and the negative terminal electrode plate, wherein each of the plurality of bipolar electrode plates includes:
an electrode substrate having a first face and a second face;
an electrical connection element overlapping at least a portion of both the first face and the second face;
a first carbon foam current collector disposed on the first face of the substrate;
a second carbon foam current collector disposed on the second face of the substrate; and
a chemically active paste disposed on both the first and second carbon foam current collectors;
a plurality of electrical separators interleaved with the plurality of bipolar electrode plates, the positive terminal electrode plate, and the negative terminal electrode plate; and
an electrolyte disposed within the housing.
